(19) United States
(12) Patent Application Publication
(10) Pub. No.: US 2015/0285561 A1
(43) Pub. Date: Oct. 8, 2015

(54) HEAT EXCHANGER

(71) Applicant: LINDE AKTIENGESELLSCHAFT, München (DE)

(72) Inventors: Manfred Steinbauer, Raisting (DE); Christiane Kerber, Pöcking (DE); Markus Hammerdinger, Tacherting (DE); Jürgen Spreemann, Rosenheim (DE)

(21) Appl. No.: 14/435,853

(22) PCT Filed: Oct. 15, 2013
(86) PCT No.: PCT/EP2013/003099

§ 371 Date: Apr. 15, 2015

(30) Foreign Application Priority Data
Oct. 18, 2012 (EP) 12007211.1

(51) Int. Cl. F28D 7/02; B23P 15/26

(52) U.S. Cl. CPC F28D 7/024; B23P 15/26

(57) ABSTRACT

A helically coiled heat exchanger with a plurality of inlets each connected to at least one assigned tube defining a heating surface of the heat exchanger and having at least one changeover means to switch the inlet between a first operating state and a second operating state. In the first operating state, a stream of a first medium and, in the second operating state, a stream of a second medium is introduced via the inlet into the assigned tube. In the first operating state more heating surface is available to the stream of the first medium and correspondingly less heating surface is available to the stream of the second medium. In the second operating state more heating surface is available to the stream of the second medium and correspondingly less heating surface is available to the stream of the first medium.

The invention relates to a heat exchanger, in particular for the liquefaction of natural gas, or, for example, use in rectisol plants or petrochemical plants, and also to a method for adapting a heating surface of the heat exchanger to different operating situations.

Such a heat exchanger may carry one or more streams on the tube side. These tube-side streams are introduced via inlets of the heat exchanger into the heat exchanger and are distributed in each case to one or more tubes. The inlets are therefore distinctly assigned in each case to a stream.

If a heat exchanger is to be employed for sharply varying process-side loads, this means designing the heat exchanger for two or more operating situations. In most operating situations, the heating surfaces suitable for one situation are too small or too large for the streams in the next situation. The individual heating surface for one stream therefore has to be adapted to one situation and that for the other streams to other situations. This leads to considerable enlargement of the heat exchange surface and consequently also to markedly higher costs for the heat exchanger.

Proceeding from this, therefore, the subject on which the present invention is based is to improve a heat exchanger of the type mentioned in the introduction, to the effect that comparatively cost-effective adaptation to different operating situations is possible. Furthermore, the object on which the invention is based is to specify a corresponding method.

This problem is solved, on the one hand, by means of a helically coiled heat exchanger having the features of claim 1. Advantageous refinements of the invention are specified in the subclaims.

According to claim 1, a helically coiled heat exchanger according to the invention has a plurality of inlets which are connected in each case to at least one assigned tube of the heat exchanger, so that at least one stream of a first medium and one stream of a second medium can be Introduced via at least one assigned inlet in each case into the at least one tube assigned, the heat exchanger having a jacket surrounding a jacket space, in which the said tubes are arranged, so that, in particular, a stream of medium routed in the jacket space comes into indirect heat exchange with a stream of medium routed in the respective tube, and the said tubes being helically coiled in each case around a core tube of the heat exchanger.

According to the invention, then, there is provision whereby, to adapt the heating surface to different operating situations, the heat exchanger has at least one changeover means which is designed for switching to and fro or changing over at least one of the inlets between at least one first operating state and one second operating state, so that, in the first operating state, the stream or a substream of the first medium and, in the second operating state, the stream or a substream of the second medium can be introduced via the at least one inlet into the at least one assigned tube of the heat exchanger, in order, in the first operating state, to make more heating surface (to be precise, that of the at least one assigned tube) available to the stream of the first medium and to make correspondingly less heating surface available to the stream of the second medium, and in order, in the second operating state, to make more heating surface available to the stream of the second medium and to make correspondingly less heating surface available to the stream of the first medium.

The invention thus advantageously makes it possible to have the ability to changeover inlets (or corresponding connection pieces) and consequently the respectively assigned tubes and heating surfaces to the various tube-side streams. Thus, for example by means of the changeover, the heat exchange surface (also called heating surface) or part of the heat exchange surface of one medium can be made available to another medium. Thus, by the changeover, in particular, the heat exchange surface or heating surface is modified in that in each case a different number of tubes is allocated to the individual media.

Thus, for example, an embodiment is provided, in which, in a first operating situation, three inlets are available to the stream of the first medium and only one is available to the further stream of the second medium. For a second operating situation, however, the heating surface for the stream of the second medium will be larger and that for the stream of the first medium may be smaller. Correspondingly, for example, one of the three inlets for the stream of the first medium is then changed over to the stream of the second medium, and the heating surface coupled thereto is made available to the further stream of the second medium. The most diverse possible loads upon the streams for various situations can therefore be covered by means of a markedly smaller heating surface.

The invention can, of course, be applied to any number of a plurality of inlets or streams. In particular, a plurality of inlets may also be capable of being changed over in the way explained above or a plurality of changeover means may be provided. Moreover, one or more inlets may also be switched to and fro between more than two operating states or streams by means of a corresponding number of changeover means. Thus, for example, the at least one changeover means may be designed to switch at least one of the inlets to and fro between at least one first operating state and one second operating state, so that, in the first operating state, the stream or a substream of the first medium and, in the second operating state, the stream or a substream of the second medium can be introduced via the at least one inlet into the at least one assigned tube, so that, in the second operating state, one tube, a plurality of tubes or all tubes of the stream of the first medium are assigned to the stream of the second medium, so that correspondingly more heating surface is available to this and correspondingly less heating surface is available to the stream of the first medium.

In a further embodiment of the invention, there is provision whereby the changeover means for changing over the at least one inlet has a first valve for shutting off a first pipeline connected to that inlet and a second valve for shutting off a second pipeline connected to that inlet, the heat exchanger being designed to feed the stream of the first medium by the first pipeline and the stream of the second medium via the second pipeline to that inlet. If, for example, the second valve is closed and the first valve is open, only the stream of the first medium is delivered via the said inlet to the assigned tubes of the heat exchanger. In the event that the first valve is closed and the second valve is open, only the stream of the second medium is delivered via the said inlet to the assigned tubes of the heat exchanger.

An outlet, which is assigned to the respective inlet capable of being changed over and which is connected to the inlet via one or more tubes of the heat exchanger, likewise has a further changeover means, so that the outlet can be changed over correspondingly to the assigned inlet. For this purpose, the further changeover means may likewise have two valves, so that the stream drawn off in each case from the outlet can be fed to an assigned outlet pipeline.

Other devices, by means of which in each case one of a plurality of streams can be applied to an inlet or an outlet assigned to the inlet, may also be envisaged.

Preferably, the said inlets and/or the in each case assigned outlets are designed in each case as connection pieces for the heat exchanger. Such connection pieces preferably project from a pressure-carrying jacket of the heat exchanger, but may also be formed internally or be arranged in the jacket space. Moreover, the jacket surrounds a jacket space of the heat exchanger in which the said tubes of the heat exchanger are arranged, so that, in particular, a medium routed in the jacket space can come into indirect heat exchange with a medium routed in the respective tube.

Preferably, the respective inlet of the heat exchanger is connected to a plurality of assigned tubes, those tubes being anchored in a tube bottom assigned to the respective inlet or connection piece.

Especially preferably, as already mentioned, the heat exchanger according to the invention is designed as a helically coiled heat exchanger, in which the said tubes are in each case coiled, in particular, helically around the core tube of the heat exchanger, which core lube is arranged in the jacket space and extends, in particular, along a longitudinal axis of the jacket or heat exchanger, the said longitudinal axis coinciding with the vertical with respect to a heat exchanger which is arranged as intended. However, the heat exchanger could theoretically also be installed horizontally. It is also possible to apply the invention to other heat exchangers, such as, for example, straight-tube heat exchangers, plate heat exchangers or other heat exchangers.

The heat exchanger according to the invention is preferably used for the liquefaction of natural gas, in particular the changeover means being designed to changeover one of the inlets or connection pieces from a natural gas stream to a coolant stream, or vice versa. The heat exchanger according to the invention is not, of course, restricted to the use for the liquefaction of natural gas, but may also be employed, for example, in rectisol plants or petrochemical plants.

Furthermore, the problem on which the invention is based Is solved by means of a method having the features of claim 10.

Accordingly, there is provision whereby the heat exchanger has a plurality of inlets which are connected in each case to at least one assigned tube of the heat exchanger, each of the lubes which are assigned to the respective inlet defining a beating surface, at least one of the inlets being switched from a first operating state into a second operating state, so that, in the first operating state, the stream or a substream of the first medium and, in the second operating state, the stream of a substream of the second medium are introduced via the at least one inlet into the at least one assigned tube, in order, in the second operating state, to make more heating surface available to the stream of the second medium and to make correspondingly less heating surface available to the stream of the first medium.

Preferably, in the method according to the invention, the heat exchanger according to the invention is used.

Preferably, there is provision, furthermore, whereby, in the second operating state, one tube, a plurality of tubes or all tubes of the stream of the first medium is or are assigned to the stream of the second medium, so that correspondingly more heating surface is available to this and correspondingly less heating surface is available to the stream of the first medium (see also above).

Further details and advantages of the invention will be explained by means of the following figure descriptions of exemplary embodiments with reference to the figures in which:

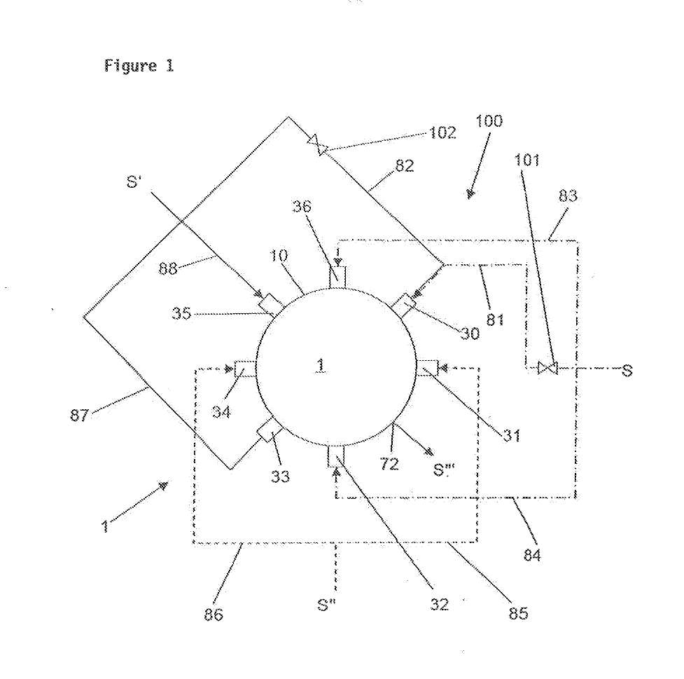

FIG. 1 shows a diagrammatic sectional view of a heat exchanger according to the invention along a cross-sectional plane running transversally to the vertical or to the longitudinal axis of the heat exchanger; and

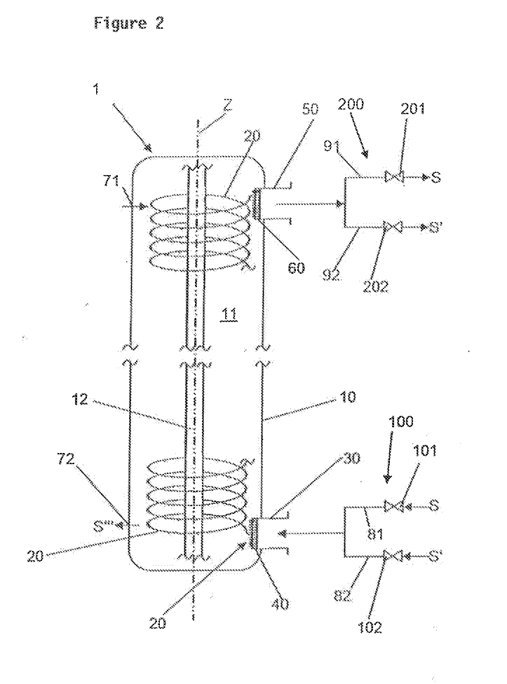

FIG. 2 shows a diagrammatic, partially sectional view of an inlet capable of being changed over and of an assigned outlet capable of being changed over and also of a helical tube, connecting the inlet to the outlet, of a heat exchanger in the manner of FIG. 1.

FIG. 1 shows, in conjunction with FIG. 2, a heat exchanger 1 according to the invention in the form of a helically coiled heat exchanger 1. The heat exchanger 1 has a pressure-carrying jacket 10, the longitudinal axis Z of which extends along the vertical Z. Alternatively to this, in a horizontal arrangement of the heat exchanger 1, the longitudinal axis Z may also run along the horizontal. The jacket 10 defines a jacket space 11, in which is arranged a core tube 12 which extends along the longitudinal axis Z, a plurality of tubes 20 being coiled helically in a plurality of layers around the core tube 12. For the sake of simplicity, only one such tube 20 is illustrated in FIG. 2. In each case a plurality of tubes 20 are anchored in an assigned tube bottom 40 and can be charged with a tube-side stream S, S′, S″ via an assigned inlet 30-36 in the form of a connection piece. For the sake of clarity, only one such connection piece 30 is depicted in FIG. 2. The tubes 20 extend from the respective inlet or connection piece 30-36, provided at the lower end of the jacket 10 of the heat exchanger 1, in the abovementioned way to an assigned outlet 50 in the form of a connection piece, one of which is illustrated by way of example in FIG. 2. Here, too, the individual tubes 20 are preferably combined in a tube bottom 60. The said inlets 30-36 may also be arranged at an upper region of the heat exchanger 1 and the assigned outlets 50 at a lower end; the tube-side flow then runs from the top downwards and the jacket-side flow from the bottom upwards.

Furthermore, in the jacket space 11, a jacket-side stream S′″ is routed in countercurrent to the tube-side streams S, S′, S″, is introduced into the jacket space 11 via an inlet 71 and is drawn off from the jacket space 72 via an outlet 72. The individual tube-side streams S, S′, S″ in this case come into indirect heat exchange with one another and with the jacket-side stream S′″.

According to FIG. 1, the heat exchanger 1 has, in particular, tree connection pieces 30, 32, 36 which are connected to pipelines 81, 82, 83 and 84, a stream S of a first medium being introduced via the pipelines 81, 83 and 84 in each case into a plurality of tubes 20 of the heat exchanger 1 which are connected to the connection pieces 30, 32, 36. Moreover, the heat exchanger 1 has two connection pieces 35, 33 which are connected to pipelines 87, 88, via which a stream S′ of a second medium is introduced in each case into a plurality of tubes 20 connected to the connection pieces 33, 35, and, furthermore, two connection pieces 31, 34 which are connected to pipelines 85, 86, via which a stream S″ of a third medium is fed in each case into a plurality of tubes 20 of the heat exchanger 1 which are connected to the connection pieces 31, 34.

In order, then, to be able to adapt the individual heating surfaces, defined by the tubes 20, of the heat exchanger 1 to different operating situations, according to the invention at least one of the inlets or connection pieces 30 is configured to be capable of being changed over, that is to say, in the present case, via the said connection piece 30, in a first operating state, either the stream S of the first medium or, in a second operating state, the stream S′ of the second medium can be fed into the connection piece 30. The available heating surface can thereby be apportioned to the existing tube-side stream S, S′. Thus, in natural gas liquefaction, depending on the operating situation, for example, more heating surface can be assigned to the natural gas stream S to be liquefied or to the heavy coolant mixture stream S′ (and correspondingly less heating surface can be assigned in each ease to the other stream).

The changeover of the connection piece 30 may be implemented, for example, in that the first pipeline 81 carrying the stream S of the first medium and connected to the connection piece 30 has a first valve 101, and in that the second pipeline 82 carrying the stream S′ of the second medium and connected to the connection piece 30 has a second valve 102. According to the position of the valves 101, 102, either the one or the other stream S, S′ can then be fed into the connection piece 30.

A further changeover means 200 is provided for the outlet 50 assigned to the connection piece 30 (cf. FIG. 2), so that the stream S, S′ drawn off in each case from the assigned outlet 50 can be fed into an assigned outlet pipeline 91, 92. For the correct distribution of the streams S, S′ to the outlet pipelines 91, 92, the further changeover means 200 may have a first valve 201 on the first outlet pipeline 93 and a second valve 202 on the second outlet pipeline 92.

The above-described principle according to the invention, can, of course, be applied to all existing tube-side streams or inlets and in each case assigned outlets.

By means of the invention, therefore, the most diverse possible load situations for different tube fractions can be covered, without the heating surface being enlarged. The costs for the heat exchanger are thereby lowered and its flexibility is increased considerably.

### LIST OF REFERENCE SYMBOLS

| | |
|---|---|
| 1 | Helically coiled heat exchanger |
| 10 | Jacket |
| 11 | Jacket space |
| 12 | Core lube |
| 20 | Tube |
| 30-36 | Inlets or connection pieces |
| 40, 60 | Tube bottom |
| 50 | Outlet or connection piece |
| 71 | Inlet jacket space |
| 72 | Outlet jacket space |
| 80-88 | Pipelines |
| 100 | Changeover means |
| 101, 102, 201, 202 | Valves |
| 200 | Further changeover means |
| S | Stream of first medium |
| S′ | Stream of second medium |
| S″ | Stream of third medium |
| S″′ | Jacket-side stream |
| Z | Longitudinal axis, vertical |

1. Helically coiled heat exchanger, with:
a plurality of inlets each connected to at least one assigned tube helically coiled around a core tube of the heat exchanger, so that at least one stream of a first medium and one stream of a second medium can be introduced via at least one assigned inlet into the assigned at least one tube, the heat exchanger having a jacket surrounding a jacket space in which the said tubes are arranged, so that a stream of a medium routed in the jacket space comes into indirect heat exchange with either the stream of the first medium or the stream of the second medium in the at least one assigned tube,
characterized
in that, each of the assigned tubes assigned to a respective inlet defines a heating surface, the heat exchanger having at least one changeover means which is designed to switch at least one of the inlets to and fro between at least one first operating state and one second operating state, so that, in the first operating state, the stream of the first medium and, in the second operating state, the stream of the second medium can be Introduced via the at least one inlet into the at least one assigned tube, in order, in the first operating state, to make more heating surface available to the stream of the first medium and make correspondingly less heating surface available to the stream of the second medium, and in order, in the second operating state, to make more heating surface available to the stream of the second medium and make correspondingly less heating surface available to the stream of the first medium.

2. Heat exchanger according to claim 1, characterized in that, to change over the at least one inlet, the changeover means has a first valve for shutting off a first pipeline connected to that inlet and a second valve for shutting off a second pipeline connected to that inlet, the heat exchanger being designed to feed the stream of the first medium via the first pipeline and the stream of the second medium via the second pipeline to that inlet.

3. Heat exchanger according to claim 1, characterized in that the at least one inlet is assigned an outlet, via which the stream of the first medium or the stream of the second medium can he drawn off from the at least one tube assigned to the inlet, further changeover means being provided, which is designed to switch the outlet to and fro between at least one first operating state and one second operating state, so that, in the first operating state, the stream of the first medium can be fed to a first outlet pipeline connected to the outlet, and so that, in the second operating state, the stream of the second medium can be fed to a second outlet pipeline connected to the outlet, the further changeover means having a first valve, provided on the first outlet pipeline, for shutting off the first outlet pipeline and a second valve, provided on the second outlet pipeline, for shutting off the second outlet pipeline.

4. Heat exchanger according to claim 1, characterized in that the inlets of the heat exchanger are designed as connection pieces of the heat exchanger being arranged at an upper or at a lower end of the heat exchanger.

5. Heat exchanger according to claim 4, characterized in that the outlet of the heat exchanger is designed as a connection piece of the heat exchanger arranged at an end of the heat exchanger which lies opposite the assigned inlet.

6. Heat exchanger according to claim 5, characterized in that the connection pieces project from the jacket or are formed internally.

7. Heat exchanger according to claim 1, characterized in that in each case a plurality of tubes is connected to the inlets or to the at least one inlet, those tubes being anchored in a tube bottom assigned to the respective inlet.

8. Heat exchanger according to claim 7, characterized in that the outlet assigned to the at least one inlet is connected to that plurality of tubes, those tubes being anchored in a tube bottom assigned to the outlet.

9. Heat exchanger according to claim 1, characterized in that, in the second operating state, one tube, a plurality of tubes or all tubes is or are assigned to the stream of the second medium, so that correspondingly more heating surface is available to this and correspondingly less heating surface is available to the stream of the first medium.

10. Method for adapting the heating surface of a helically coiled heat exchanger to different operating situations using a heat exchanger having a plurality of inlets which are connected in each case to at least one assigned tube of the heat exchanger, each of the tubes assigned to the respective inlet defining a heating surface, at least one of the inlets being switched from a first operating state into a second operating state, so that, in the first operating state, a stream of a first medium and, in the second operating state, a stream of a second medium are introduced via the at least one inlet into the at least one assigned tube, in order, in the second operating state, to make more heating surface available to the stream of the second medium and to make correspondingly less heating surface available to the stream of the first medium.

11. Method according to claim 10, characterized in that, in the second operating state, one tube, a plurality of tubes or all tubes is or are assigned to the stream of the second medium, so that correspondingly more heating surface is available to this and correspondingly less heating surface is available to the stream of the first medium.
